(19) United States
(12) Patent Application Publication
(10) Pub. No.: US 2011/0015976 A1
(43) Pub. Date: Jan. 20, 2011

(54) METHOD AND SYSTEM FOR A CUSTOMIZED VOUCHER

(76) Inventors: Eric Lempel, Hayward, CA (US); Jennifer Moonyoung Cho, Redwoody City, CA (US); Gary Zalewski, Oakland, CA (US)

Correspondence Address: William S. Frommer;c/o FROMMER LAWRENCE & HAUG LLP, 745 Fifth Avenue, New York, NY, 10151, US

(21) Appl. No.: 12/505,584

(22) Filed: Jul. 20, 2009

(51) Int. Cl. G06Q 30/00; G06F 15/16; G06Q 50/00

(52) U.S. Cl. 705/14.12; 705/14.23; 705/14.39; 709/204; 705/26.1

(57) ABSTRACT

This invention relates to a voucher system and method for generating and redeeming vouchers. The voucher system includes a generation module adapted to generate a voucher code upon a request of a purchaser and a redemption module adapted to utilize the voucher code such that a recipient, upon validation of the voucher code, accesses the associated items. The voucher code is associated with at least two items selected by the purchaser. The generation module allows the purchaser to select an item to be associated with the voucher code from a wish-list of the purchaser or the recipient. Upon redeeming the voucher, the recipient receives the associated items at a designated user account.

### BACKGROUND

1. Field of the Invention

This invention relates generally to a method and system for providing and redeeming a customized voucher. More specifically, the customized voucher may be generated upon a request such that items associated with the customized voucher may be exchanged with other items of equivalent value upon redemption of the voucher by a recipient.

2. Background Discussion

A voucher may be generally thought of a bond which is worth a certain monetary value and which may typically be spent for specific reasons or on specific goods. Examples may include housing, travel and food vouchers.

Monetary vouchers may be used, for example, to entitle a recipient to purchase items using the funds associated with the monetary amount of the vouchers.

A recipient may redeem a monetary voucher at a store and receive store credit for the amount of a monetary voucher. A monetary voucher may be in the form of a card that is sold at a retail store for a particular denomination or amount. A recipient of the monetary voucher may redeem the monetary voucher for the associated amount of funds.

### SUMMARY

Embodiments of the present invention are directed to methods and apparatus for a voucher, coupon, certificate or other document (either tangible or an electronic representation), that may be redeemed for access to products, such as products that may be downloaded from a website and/or redeemed for electronic representations of items (virtual items) and/or redeemed for electronic funds, or digital money. The items may be exchanged or returned.

One embodiment of the present invention is directed to a voucher system for utilizing vouchers via a network. The voucher system includes a generation module adapted to generate a voucher code upon a request of a purchaser and a redemption module adapted to utilize the voucher code such that a recipient, upon validation of the voucher code, accesses the associated items. (The purchaser, or provider, and the recipient may be the same person, or party, in the event a person purchases a voucher for themselves.) The voucher code is typically associated with at least two items selected by the purchaser. The generation module allows the purchaser to select an item to be associated with the voucher code from a “wish-list” of the purchaser or the recipient. Upon redeeming the voucher, the recipient receives the associated items at a designated user account.

Another embodiment of the present invention is directed to a voucher system for utilizing vouchers via a network. This includes a generation module adapted to generate a voucher code upon a request of a purchaser. The voucher code is associated with one or more items selected by the purchaser, such that the purchaser can assign one or more attributes to each of the one or more items. A redemption module adapted to utilize the voucher code such that a recipient, upon validation of the voucher code, accesses the associated one or more items. Upon redeeming the voucher, the recipient receives the associated one or more items at a designated user account, and receives notification of the one or more attributes assigned to each of the one or more items.

Yet another embodiment of the present invention is directed to the system described above and the attribute indicates that an associated item is returnable.

Yet another embodiment of the present invention is directed to the system described above wherein the attribute indicates that an associated item is exchangeable for another equivalent item or an equivalent amount of electronic funds.

Yet another embodiment of the present invention is directed to the system described above wherein the redemption module displays options associated with each of the one or more items to the recipient in accordance with the attribute assigned by the purchaser.

Yet another embodiment of the present invention is directed to the system described above wherein the generation module prints the voucher code on a card.

Yet another embodiment of the present invention is directed to the system described above, wherein the generation module generates a list of items that have equivalent values with an item selected by the purchaser.

Yet another embodiment of the present invention is directed to the system described above, wherein the attribute associates a message in a text form or a graphical form with the voucher code.

Yet another embodiment of the present invention is directed to the system described above, wherein when the recipient accesses an associated item upon redeeming the voucher code, a recognition message is transmitted to the purchaser.

Yet another embodiment of the present invention is directed to the system described above, wherein the associated items include one or more of predetermined digital funds and one or more of downloadable digital contents.

Yet another embodiment of the present invention is directed to the system described above, wherein the redemption module is a Playstation3 terminal, a Playstation®Portable, or Media Go.

Yet another embodiment of the present invention is directed to the system described above, wherein the recipient exchanges the associated items with other items of equivalent value upon utilizing the voucher code.

Yet another embodiment of the present invention is directed to the system described above, wherein the redemption module generates a list of items that have equivalent values with the associated item.

Yet another embodiment of the present invention is directed to the system described above, wherein the purchaser modifies a cost of the voucher by modifying selection of the one or more items associated with the voucher by the purchaser.

Yet another embodiment of the present invention is directed to the system described above, wherein the generation module permits the purchaser to select an item to be associated with the voucher code from a pre-determined list associated with the recipient.

Other embodiments of the present invention include the methods described above but implemented using apparatus or programmed as computer code to be executed by one or more processors operating in conjunction with one or more electronic storage media.

### BRIEF DESCRIPTION OF THE DRAWINGS

To the accomplishment of the foregoing and related ends, certain illustrative embodiments of the invention are described herein in connection with the following description and the annexed drawings. These embodiments are indicative, however, of but a few of the various ways in which the principles of the invention may be employed and the present invention is intended to include all such aspects and their equivalents. Other advantages, embodiments and novel features of the invention may become apparent from the following description of the invention when considered in conjunction with the drawings. The following description, given by way of example, but not intended to limit the invention solely to the specific embodiments described, may best be understood in conjunction with the accompanying drawings, in which:

FIG. 1 illustrates a perspective view of a voucher according to an embodiment of the present invention;

FIG. 2 illustrates an example of a network in which vouchers may be generated and/or redeemed according to an embodiment of the present invention;

FIG. 3 illustrates an example of a processing apparatus that includes a voucher generation module, voucher redemption module and billing module according to an embodiment of the present invention;

FIG. 4 shows an example of an algorithm used to generate a voucher according to an embodiment of the present invention;

FIG. 5 shows an example of a menu screen to determine content of a voucher according to an embodiment of the present invention;

FIG. 6 shows an example of a display that may be used to generate a voucher according to an embodiment of the present invention;

FIG. 7 shows a series of steps that may be used to redeem a voucher according to an embodiment of the present invention;

FIG. 8 shows a menu display with selected voucher content for a user to choose;

FIG. 9 shows a billing algorithm according to an embodiment of the present invention; and

FIG. 10 shows an example of an electronic representation of a voucher according to an embodiment of the present invention.

FIG. 11 shows an example of an algorithm used to generate a voucher according to an embodiment of the present invention.

FIG. 12 shows an example of an algorithm used to redeem a voucher according to an embodiment of the present invention.

### DETAILED DESCRIPTION

It is noted that in this disclosure and particularly in the claims and/or paragraphs, terms such as “comprises,” “comprised,” “comprising,” and the like can have the meaning attributed to it in U.S. patent law; that is, they can mean “includes,” “included,” “including,” “including, but not limited to” and the like, and allow for elements not explicitly recited. Terms such as “consisting essentially of” and “consists essentially of” have the meaning ascribed to them in U.S. patent law; that is, they allow for elements not explicitly recited, but exclude elements that are found in the prior art or that affect a basic or novel characteristic of the invention. These and other embodiments are disclosed or are apparent from and encompassed by, the following description. As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Furthermore, the detailed description describes various embodiments of the present invention for illustration purposes and embodiments of the present invention include the methods described and may be implemented using one or more apparatus, such as processing apparatus coupled to electronic media. Embodiments of the present invention may be stored on an electronic media (electronic memory, RAM, ROM, EEPROM) or programmed as computer code (e.g., source code, object code or any suitable programming language) to be executed by one or more processors operating in conjunction with one or more electronic storage media.

As stated above, the present invention is directed to vouchers that may be generated and redeemed for access to electronic funds and/or tangible articles (video games, CDs, DVDs, clothing) and/or virtual articles (virtual accessories) or a combination of electronic funds and tangible articles and virtual articles. A recipient of a voucher may choose to accept, exchange, or return articles accessible through these vouchers.

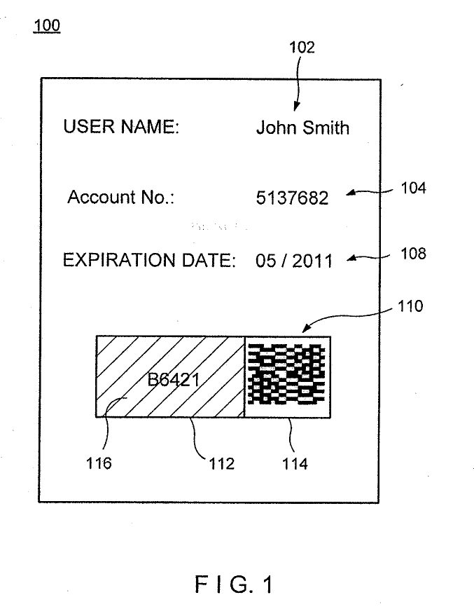

FIG. 1 illustrates a perspective view of a voucher 100 according to an embodiment of the present invention.

As shown in FIG. 1, an example of a voucher 100 identifies a user name 102 (John Smith), an Account No. 104 (U.S. Pat. No. 5,137,682), an expiration date 108 (May 2011) and a voucher code 110.

Voucher 100 may take the form of a coupon, certificate, ticket or other document, which may be in a tangible form (e.g., plastic card) or an electronic representation that may be downloaded from a remote location, printed, or transmitted at a user terminal. Voucher 100 may be used as a prepaid voucher that may be redeemed to purchase items (e.g., video games, video game accessories or tangible articles) or redeemed for electronic funds to fund an online “wallet” or an online account in order to purchase content or goods without a credit card.

Vouchers, such as voucher 100, may be purchased at a retail or “point-of-sale” location such as Blockbuster™, Rite-Aid™, and 7-Eleven™ Wal-Mart™, Best Buy™, and Target™ stores. Alternatively, vouchers may be purchased via a network from a user terminal and accessed either at that user terminal and/or a remote user terminal.

User name 102 is used to identify a user or name of an account holder. Account number 104 is used to associate the account with a specific user and expiration 108 is used to identify an expiration date of the voucher. Voucher code 110 may include, for example, an alpha-numeric code portion 112 (B6421) or a barcode portion 114 or both an alpha-numeric code portion 112 (B6421) and a barcode portion 114. Both the alpha-numeric code portion 112 and barcode portion may be obscured with a covering layer 116. Alternatively, as shown in FIG. 1, only the alpha-numeric (e.g., human-readable) portion 112 may be obscured.

The covering layer 116 may be, for example, a “scratch-off” material, similar to those used in lottery tickets and other scratch-and-win type contests. The scratch-off layer 116 obscures the voucher code 110, which includes portions 112 and 114, from observation by both the voucher distributor and individuals who may see the voucher prior to purchase. This prevents unauthorized users from accessing the voucher and prevents access of the voucher until after the voucher has been sold. In this way, the voucher code 110 is secure. After the voucher 100 has been purchased or transmitted to a valid user, a user may scratch away the layer 116 to reveal the voucher code 110. This voucher code may entered into a user account, at a user terminal (such as home computer-with software applications such as Media Go, Playstation®, or Playstation®Portable (PSP®)) to enable access to the voucher content. The bar code portion 114 may be scanned at a retail or point of sale location to enable the user to purchase merchandise associated with the voucher 100.

In an embodiment in which the voucher 100 is retrieved electronically (i.e., from a client or user terminal or Playstation®, or PSP®) the user may perform an electronic scratch-off operation that mimics a physical scratch-off action. This is described in more detail in relation to FIG. 10 herein.

The voucher code 110, once revealed, enables the authorized user to access both electronic funds and/or articles (either tangible articles or electronic representations of articles) at the same time using the single voucher code 110. Thus, generally, upon validation of the voucher code (either at a point of sale location or by entering the voucher code 110 into a user account on-line), a user selects one or more of a first item and/or selects one or more second items at substantially the same time (the user can access both types of items in the same session upon validation of the voucher code 110).

The first items and second items may include a monetary redemption value such as electronic funds, typically a specific monetary value, for example a purchaser goes to a store or other retail venue (physical or website), pays $50 (for example) and obtains a voucher with $50 to spend on designated merchandise. This merchandise may be, for example, video games, music, movies, CDs, DVDs, clothing, or gaming accessories (e.g., a controller, headphones, camera, etc.) that may be purchased online or in a physical store or retail location. Any merchandise that is available at the particular venue (physical or virtual (website) may be purchased using the voucher.

The first items and second items may also include non-monetary articles such as video games, music, movies, CDs, DVDs, bonus footage (outtakes, “behind-the scenes” footage, alternate endings, additional songs, interviews with the actors/directors/singers, bloopers etc.) plug-ins, plug-and-play, demo material, rental privileges, unlockable content, bundles of audio and video content (e.g., 2 movies and 3 music CDs), tangible accessories such as a portable battery pack, headphones or adapter or electronic (virtual) accessories such as accessories for an avatar (e.g., a sword for an avatar, clothing for an avatar), accessories for video games, virtual reality media (VRM) articles, and other virtual articles. The first items and second items may also include characters, upgrades, and weapons of video games. These items may be purchased at a retail store outlet or retrieved via a user terminal such as downloading virtual articles from a website.

The use of electronic funds may facilitate a retailer to offer specific promotional programs in which a unique product would be available for downloading when purchasing or accessing a voucher from that specific retailer. A specific example is a BEST BUY™ store may offer a virtual yellow shirt similar to shirts worn by employees as an article to be redeemed with a voucher. This type of product could be associated with the voucher code 110 of voucher 100.

Any combination of first items and second items may be accessed by a voucher 100. The content associated with the voucher 100 (monetary value and/or articles (real or virtual)) is determined at the time the voucher is generated. Some examples of combination of items are described below.

For example the content of the voucher 100 may be a $20.00 monetary value and a video game such as KILLZONE®. The $20.00 worth of electronic funds may be placed into an online account of the user. These funds may then be saved in the account for use at a later time. The video game (KILLZONE®) may be obtained at a retail store location or online.

Another example of the redemption content of voucher 100 may be a $20.00 monetary value, in the form of electronic (digital) funds and a tangible article. The tangible article may be a retail-specific item such as a yellow BESTBUY™ shirt, similar to those worn by employees while working at the store. The shirt may be picked-up at the retail location or ordered on-line. For example, the tangible article (e.g., BESTBUY™ shirt) may be given to the voucher holder at one time (while the holder is at the store) and the electronic funds may be deposited into the user's account to be used at a time the user chooses.

Yet another example of the redemption content of the voucher 100 could be an amount of electronic funds ($20.00) and a virtual accessory such as a weapon to be used in a video game.

Yet another example of the redemption content of voucher 100 is a virtual accessory (e.g., a helmet for an avatar) and authorization to access a demo of a new, as yet unreleased, video game.

Yet another example of the redemption content of voucher 100 is a tangible accessory, such as a hat for the user, and a virtual accessory such as a hat (which may be matching style) for an avatar.

Yet another example of the redemption content of voucher 100 is electronic funds and bonus songs, such as unreleased or acoustic versions of one or more songs.

Yet another example of the redemption content of voucher 100 is a virtual weapon that may be used in a video game and additional video game content. The additional video game content may include in-game advertising content. This advertising content may be related to the virtual weapon and may advertise virtual accessories related to the virtual weapon.

Yet another example of the redemption content of voucher 100 is a version of a game that permits the user to win a virtual article, such as a particular hat/clothing item or weapon and a coupon to redeem the actual physical corresponding article or a virtual representation of the article. For example, voucher 100 may entitle a user could download a video game, during the course of which he/she won a baseball cap and the voucher 100 also provides a coupon for redeeming a physical baseball cap similar to the virtual baseball cap that was won by the user while playing the game.

Yet another example of the redemption content of voucher 100 is electronic funds and rental privileges for a selected quantity and/or type of movie rentals. Specifically, $10.00 worth of electronic funds and 5 movie rentals with a “PG” rating.

Yet another example of the redemption content of voucher 100 is electronic funds and unlockable footage for a video game. The unlockable footage may entitle the user to specific accessories which can be purchased with the electronic funds.

Yet another example of the redemption content of voucher 100 is electronic funds and a preselected menu of video games that the user may select from. Specifically, the user may see a menu of 10 video game titles and may select any two video games.

Yet another embodiment of the present invention is directed to a voucher system for utilizing vouchers via a network. This includes a generation module adapted to generate a voucher code upon a request of a purchaser. The voucher code is associated with one or more items selected by the purchaser. The items may include, for example, tangible items or virtual items that are used in a gaming environment, such as accessories used in conjunction with a game, or additional content (e.g., audio and/or video content), or a combination of tangible items and virtual items. The purchaser of the voucher can assign one or more attributes to each of the items. The attribute may be, for example, a video message and/or text message and/or graphic and/or photograph that identifies the purchaser or includes content that the purchaser desires to be conveyed to the recipient.

Alternatively, the attribute indicates that an associated item is returnable, that an associated item is exchangeable for another equivalent item(s) or an equivalent amount of electronic funds. The equivalent items may be predetermined based on typical price or value of the items.

The attribute may be customized by the purchaser and can be displayed each time the recipient accesses the item, or may be displayed to the recipient only once or a specified number of times. The frequency of display of the message may be determined by the purchaser. Alternatively, the recipient can modify the display to skip the message after viewing it the first time. The attribute may include, for example, a greeting or message or recognition that the item was provided by the purchaser. Thus, the purchaser may receive recognition for the purchase and gift to the recipient.

Yet another embodiment of the present invention is directed to the system described above, wherein the generation module generates a list of items that have equivalent values with an item selected by the purchaser.

Yet another embodiment of the present invention is directed to the system described above, wherein the generation module permits the purchaser to select an item to be associated with the voucher code from a pre-determined list associated with the recipient.

Another embodiment of the present invention is directed to a method and apparatus for redeeming a voucher that has been customized by a purchaser, or provider. The apparatus includes a redemption module adapted to utilize the voucher code such that a recipient, upon validation of the voucher code, accesses the associated one or more items. Upon redeeming the voucher, the recipient receives the associated one or more items at a designated user account, and receives notification of the one or more attributes assigned to each of the one or more items.

Yet another embodiment of the present invention is directed to the system described above wherein the redemption module displays options associated with each of the one or more items to the recipient in accordance with the attribute assigned by the purchaser.

Yet another embodiment of the present invention is directed to the system described above, wherein the attribute associates a message in a text form or a graphical form with the voucher code.

Yet another embodiment of the present invention is directed to the system described above, wherein when the recipient accesses an associated item upon redeeming the voucher code, a recognition message is transmitted to the purchaser or provider.

Yet another embodiment of the present invention is directed to the system described above, wherein the associated items include one or more of predetermined digital funds and one or more of downloadable digital contents.

Yet another embodiment of the present invention is directed to the system described above, wherein the redemption module is a Playstation3 terminal, a Playstation®Portable, or Media Go.

Yet another embodiment of the present invention is directed to the system described above, wherein the recipient exchanges the associated items with other items of equivalent value upon utilizing the voucher code.

Yet another embodiment of the present invention is directed to the system described above, wherein the redemption module generates a list of items that have equivalent values with the associated item.

Yet another embodiment of the present invention is directed to the system described above, wherein the purchaser or provider modifies a cost of the voucher by modifying selection of the one or more items associated with the voucher by the purchaser.

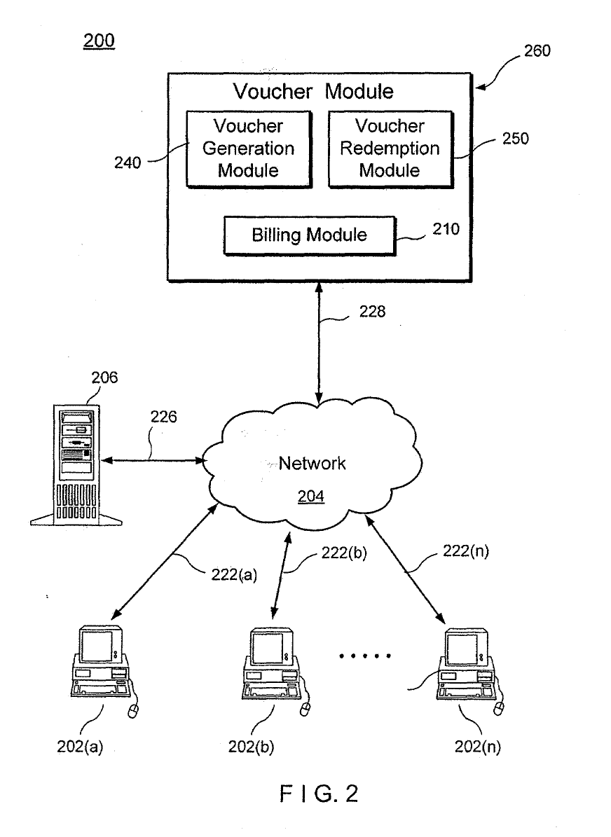

FIG. 2 illustrates an example of a network 200 in which vouchers may be generated and/or redeemed according to an embodiment of the present invention.

Embodiments of the present invention may be implemented using one or more processing devices, or processing modules. The processing devices, or modules, may be coupled such that portions of the processing and/or data manipulation may be performed at one or more processing devices and shared or transmitted between a plurality of processing devices. For example, a voucher, as shown in FIG. 1, may be generated by a user at one location and accessed at another location, by that user or another user.

Thus, an example of the invention is described in a network environment. Specifically, FIG. 2 shows a network environment 200 adapted to support various embodiments of the present invention. The exemplary environment 200 includes a network 204, a voucher module, or facility 260. ( A module, as used herein, is for example, a series of instructions stored on a computer-readable, or an electronic storage medium storing program code, or a memory unit storing instructions that is coupled to an associated dedicated processing unit for execution of the instructions, the module may be a plugin unit, stand alone set of instructions, or program code or may be an integral part of a larger component. Each module may be stored in a separate memory or a common computer memory.) FIG. 2 also show a plurality of terminals 202(a) . . . 202(n), where “n” is any suitable number and a kiosk 206.

The network 204 is, for example, any combination of linked computers, or processing devices, adapted to transfer and process data. The network 204 may be private Internet Protocol (IP) networks, as well as public IP networks, such as the Internet that can utilize World Wide Web (www) browsing functionality. An example of a wired network is a network that uses communication busses and MODEMS, or DSL lines, or a local area network (LAN) or a wide area network (WAN) to transmit and receive data between terminals. An example of a wireless network is a wireless LAN. Global System for Mobile Communication (GSM) is another example of a wireless network. The GSM network is divided into three major systems which are the switching system, the base station system, and the operation and support system (GSM). Also, IEEE 802.11 (Wi-Fi) is a commonly used wireless network in computer systems which enables connection to the Internet or other machines that have Wi-Fi functionality. Wi-Fi networks broadcast radio waves that can be picked up by Wi-Fi receivers that are attached to different computers.

Voucher module, or facility 260 includes a billing module 210, voucher generation module 240 and voucher redemption module 250. The voucher module 260 may be for example a server computer operatively connected to network 204, via bi-directional communication channel, or interconnector, 228, which may be for example a serial bus such as IEEE 1394, or other wire or wireless transmission medium. The terms “operatively connected” and “operatively coupled”, as used herein, mean that the elements so connected or coupled are adapted to transmit and/or receive data, or otherwise communicate. The transmission, reception or communication is between the particular elements, and may or may not include other intermediary elements. This connection/coupling may or may not involve additional transmission media, or components, and may be within a single module or device or between the remote modules or devices.

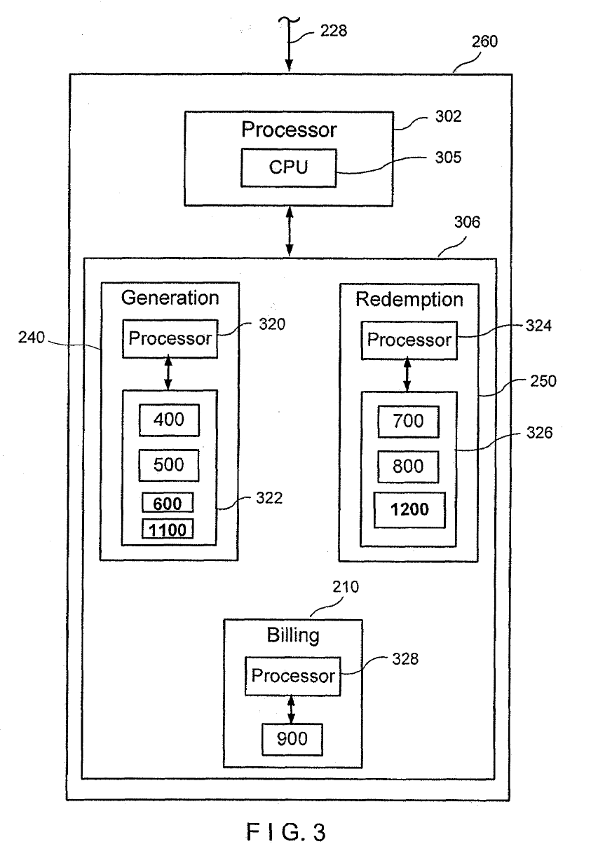

The voucher module 260 is adapted to transmit data to, and receive data from, terminals 202(a) . . . (n) and kiosk 206, via the network 204. Voucher module 260 is described in more detail with reference to FIG. 3, herein.

Terminals 202(a) . . . (n) (where “n” is any suitable number) (generally referred to as 202) are coupled to network 204 via an associated bidirectional communication medium 222(a) . . . (n), which may be for example a serial bus such as IEEE 1394, or other wire or wireless transmission medium. Terminals 202 may be communication appliances, or user locations, or subscriber devices, or client terminals. For example, terminals 202 may be software applications such as Media Go, or computers, or other processing devices such as a desktop computer, laptop computer, personal digital assistant (PDA), wireless handheld device, Playstation®, Playstation®Portable (PSP®), and the like. They may be capable of processing and storing data themselves or merely capable of accessing processed and stored data from another location (i.e., both thin and fat terminals).

Terminal 202(a) may be a user terminal at which a user receives a voucher that was specified, or ordered at a different terminal (e.g., terminal 202(b)). Alternatively, terminal 202(n) may be a terminal at a retail store location at which a user specifies a voucher that is to be accessed at a different terminal (i.e., 202(a) and/or 202(b)). Kiosk 206 is also adapted and capable of specifying a voucher that may be accessed at another terminal (e.g. 202(a)). A user may also access a voucher at kiosk 206. The kiosk 206 is coupled to network 204 via bi-directional communication medium 226.

Terminals 202 typically include a display unit and an input unit. The display unit is used to display the data generated by the system 200 as well as input generated at the terminal 202, and the voucher generated by voucher module 260. The display unit of terminal 202 may be, for example, a monitor, LCD (liquid crystal display), a plasma screen, a graphical user interface (GUI) or other unit adapted to display output data typically by a representation of pixels to form text and graphic and video date. The input unit may include devices such as a keyboard, mouse, track ball and/or touch pad or any combination thereof.

The voucher module 260 and terminals 202 and kiosk 206 typically utilize a network service provider, such as an Internet Service Provider (ISP) or Application Service Provider (ASP) (ISP and ASP are not shown) to access resources of the network 204.

FIG. 3 illustrates an example of voucher module 260 that includes a processor module 302, a memory module 306, a voucher generation module 240, a voucher redemption module 250, and a billing module 210. Voucher module 260 is coupled to network (204 in FIG. 1) via bi-direction communication medium 228.

Processor module 302 is coupled to voucher generation module 240, voucher redemption module 250, and billing module 210 via an associated communication link to enable processor module 302 to coordinate processing operations of the modules. The processor module 302 includes a CPU 305, which is typically a processor that includes an arithmetic logic unit (ALU), which performs arithmetic and logical operations, and a control unit (CU), which extracts instructions from memory and decodes and executes them, utilizing the ALU when necessary. An I/O interface may be used to operatively couple the components of processor module 302.

Memory 306 stores programs, which include, for example, a web browser, algorithms, as well as typical operating system programs (not shown), input/output programs (not shown), and other programs that facilitate operation of server voucher module 260. The web browser (not shown) is for example an Internet browser program such as Internet Explorer™. Memory module 305 may be, for example, an electronic storage medium, such as an other electronic storage repository that can store data used by voucher module 260. The memory module 306 may include, for example, RAM, ROM, EEPROM or other memory media, such as an optical disk, optical tape, CD, or a floppy disk, a hard disk, or a removable cartridge, on which digital information is stored in the form of bits. The memory module 306 may also be remote memory coupled to processing module 302 via wired or wireless bi-directional communication medium.

Voucher generation module 240 includes a dedicated processor 320 and memory 322 which includes memory or storage locations 400, 500, 600, and 1100, which are used to store generation algorithms and/or generation program code that may be stored on an electronic and/or computer-readable medium and executed by one or more processors to generate a voucher according to embodiments of the present invention and/or generate a display.

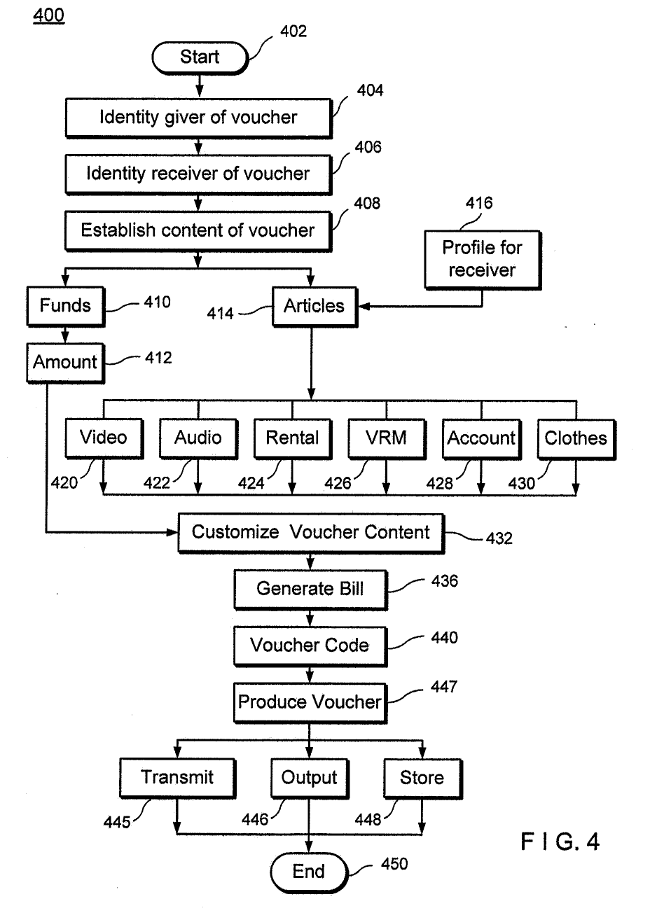

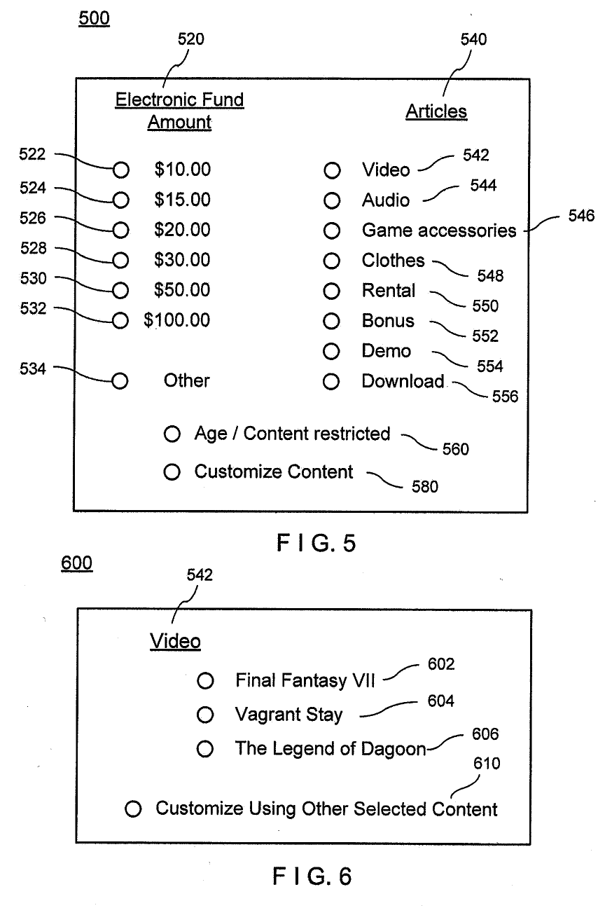

Algorithm 400 is described in relation to FIG. 4 and output displays 500 and 600 are described in relation to FIG. 5 and FIG. 6, respectively.

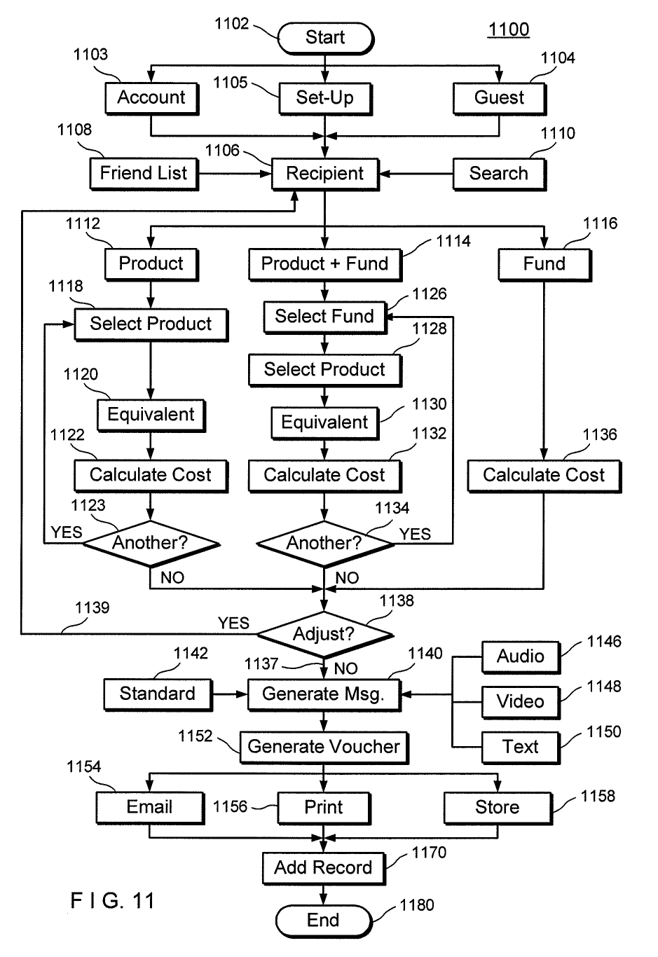

The generation module 240 in FIG. 3 includes generation algorithm 1100 for generating a voucher, which is described in relation to FIG. 11.

The voucher generation module 240 is adapted to receive input from a user, typically utilizing a terminal (shown as element 202 in FIG. 1), or kiosk (shown as element 206 in FIG. 1), as described herein, that represents content for a voucher to be generated and provided for redemption. The user who purchases a voucher may be considered a “purchaser”. The user who receives a voucher from the purchaser may be considered a “recipient”. The purchaser is provided with a menu of options to select from to form the content of the voucher. The content of the voucher may be electronic funds, and/or electronic representations of articles (virtual articles) and/or tangible articles (actual articles) and/or items from a wish-list of the recipient or the purchaser. This is described in more detail with relation to FIGS. 4, 5 and 6 herein. The purchaser can select desired content at a kiosk (206) or retail terminal (202(n)) or other terminal (202(b) or 202(c)).

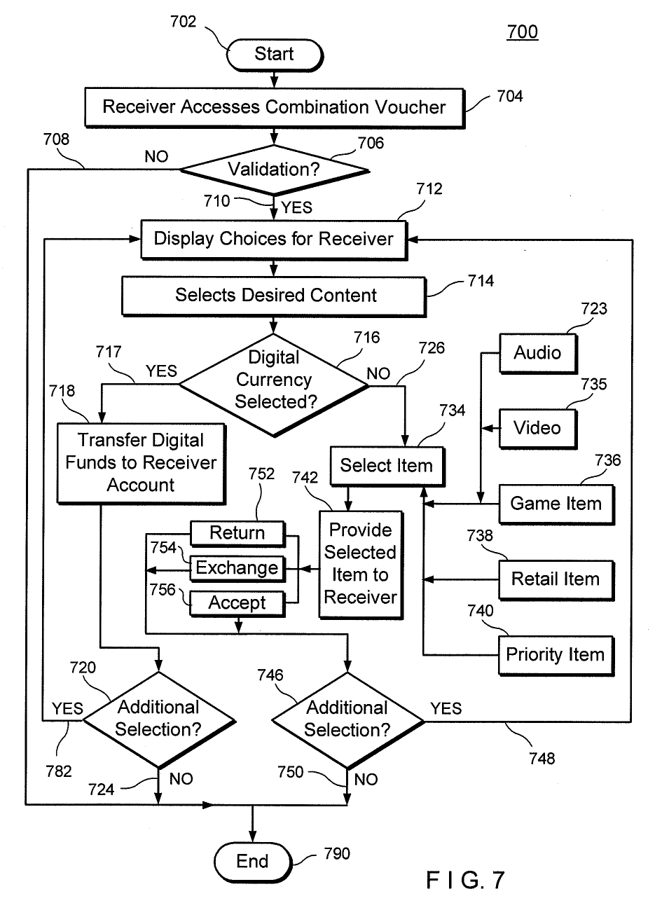

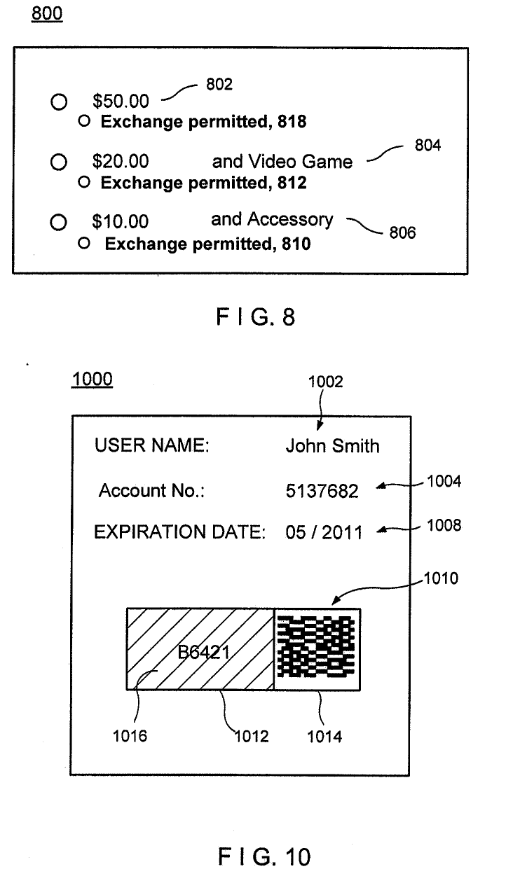

Voucher redemption module 250 includes a dedicated processor 324 memory module 326 that includes storage locations 700, 800, and 1200, which are used to store redemption algorithms and/or redemption program code that may be stored on an electronic and/or computer-readable medium and executed by one or more processors to redeem a voucher according to embodiments of the present invention. Algorithm 700 is described in relation to FIG. 7 and output display 800 is described in relation to FIG. 8. The voucher redemption module 250 receives a voucher code, typically from a receiver, and confirms that the voucher code is valid. If so, the voucher redemption module 250 correlates the voucher code to the content and provides an interface for the user to redeem the voucher.

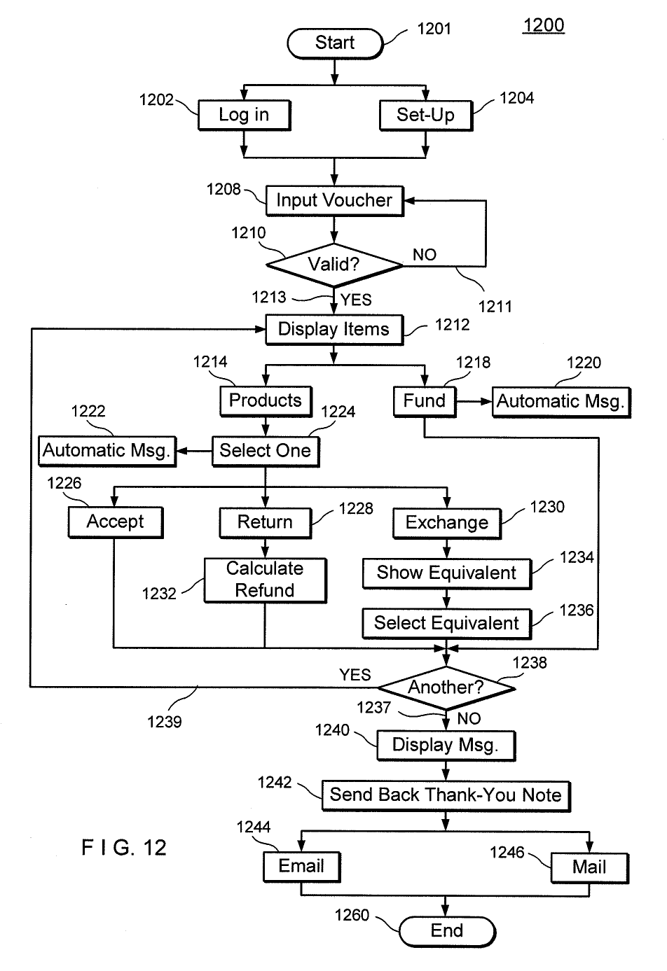

The redemption module 250 in FIG. 3 includes redemption algorithm 1200 for redeeming a voucher, which is described in relation to FIG. 12.

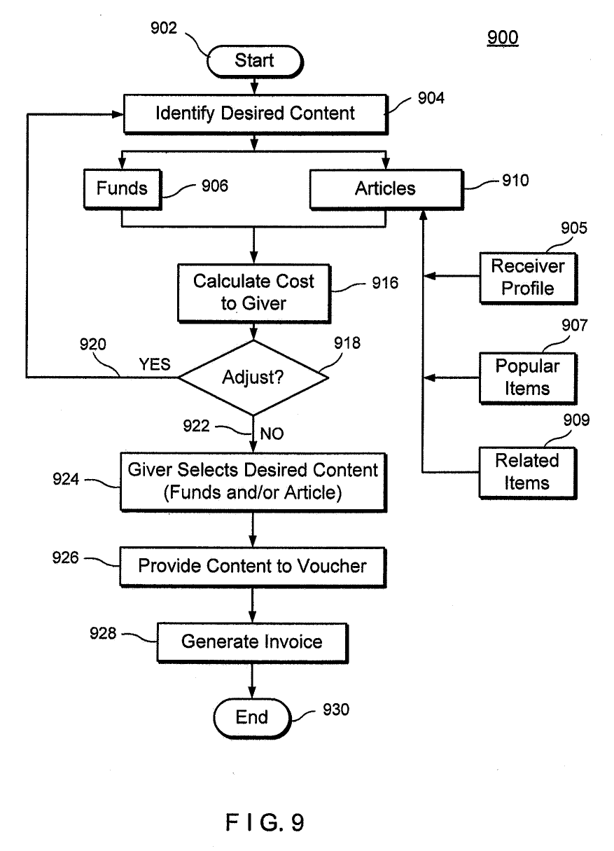

Billing module 210 includes dedicated processor 328 and memory 900 used to store a billing algorithm 900. Billing algorithm 900 is described in more detail in relation to FIG. 9 herein.

FIG. 4 shows an example of an algorithm used to generate a voucher according to an embodiment of the present invention. As shown in FIG. 4, the algorithm may be illustrated as a flowchart of steps 400 to implement an embodiment of the present invention. The steps 400 may be executed by a processor, or otherwise executed to perform the identified functions and may also be stored in one or more memories and/or one or more electronic and/or computer-readable media. For example, the steps of FIG. 4 may be stored on a computer-readable medium, such as ROM, RAM, EEPROM, CD, DVD, or other non-volatile memory. The program code stored on an electronic memory medium is a structural element. The process 400 begins with start step 402.

An identification of the “purchaser” or “provider” or person or party requesting or specifying the voucher is established, as shown in step 404. An identification of a “receiver” or person receiving the voucher is established as shown in step 406.

Content of the voucher is determined, as shown in step 408. The voucher content may include electronic funds, as shown in step 410, and/or articles, as shown in step 414.

The funds, which are typically electronic funds or digital funds or other representation of a currency that may be used to purchase predetermined type of goods, may be specified to be a particular amount, as shown in step 412.

The purchaser may also select one or more virtual and/or one or more tangible articles to be included on the voucher, as shown in step 414. When articles are selected, a determination of whether the recipient has a profile, or list of desired articles (also know as a “wish-list”), may be accessed, as shown in step 416. The list of desired articles is also known as a wish-list. The purchaser may also select an item from the wish-list of the purchaser. These articles could be game accessories for a favorite game, desired clothing to be worn, desired videos, desired CDs and other articles that relate to the receiver's activity. In the event a recipient has a profile, or list of desired items (the wish-list), those may be used to populate a menu of possible articles for the purchaser to select from when establishing the content of the voucher.

The articles that may be used as content for the voucher include, for example, videos (step 420), audio (step 422), rentals (step 424), virtual reality media (VRM) (step 426), accessories (step 428), clothing (step 430) or substantially any other article that may be redeemed.

Step 432 shows that the content that corresponds to the voucher may be customized. For example when video content (420) is selected, the video content may be edited based on other selections. For example, if an accessory, such as a sword (accessory 428) is selected the video (420) may be edited, or customized to include the accessory (sword). Thus, the voucher provides video content that is dynamically edited based on other voucher content.

Similarly, the content may be customized to include the ability for a user to spend the funds (412) on an accessory (428) shown in the video (420).

Once the voucher content has been established, a fee, or bill for the voucher is generated, as shown in step 436. Thus, the purchaser is notified of the amount the voucher cost. The bill, or invoice may be printed, emailed, stored or otherwise transferred. (Typically, the billing module 210 will be used for generating the bill or invoice, as described in relation to FIG. 9.)

A voucher code is generated that associates the voucher content, as shown in step 440. For example, the voucher code may be associated with a particular receiver. Alternatively, a voucher code may merely identify the voucher content and be used by any person who obtains the voucher code.

A voucher is produced as shown in step 447. This voucher may be transmitted electronically to an email address, or other terminal (step 445), and/or output, such as printed in paper or on a card (step 446) and/or stored in a memory location (step 448), either at the voucher module 260 or other remote memory location.

The steps end as shown in step 450.

FIG. 5 shows an example of a menu display 500 to determine content of a voucher according to an embodiment of the present invention. Menu 500 may be displayed at a terminal (shown as element 202 in FIG. 1) display unit. (The menu display 500 may be generated for example by step 408 as shown in FIG. 4 during the determination of content for the voucher.) The menu identifies a list of fund amounts 520 and a list of articles 540. The funds 520 include various denominations: $10.00 (522); $15.00 (524); $20.00 (526); $30.00 (528); $50.00 (530); $100.00 (532) and other (534). The amount of funds desired to be placed on the voucher may be selected by the purchaser.

The articles 540 include: videos (542); audio (544); game accessories (546); clothes (548); rental (550); bonus (552); demo (554), and downloads (556).

The content selected by the purchaser is the content that may be redeemed by the receiver. However, as described in relation to FIG. 8, a voucher, generated based on the purchaser's selection, may provide the recipient with a choice of articles and various combinations of fumds and articles. Thus, the purchaser may select to give a voucher that the recipient may redeem for a certain amount of funds or funds and accessories or funds and video games.

FIG. 5 also shows that the purchaser may restrict the possible content that the recipient may redeem the voucher for. For example, as shown by menu selection button 560, the purchaser can prevent mature content from being redeemed by the recipient.

Furthermore, the purchaser can choose to customize content based on selected voucher content. For example, if a recipient redeems the voucher for certain video content that is downloaded, the downloaded version may have customized content based on other redeemed content. Specifically, when a user redeems the voucher for an accessory such as sword, the downloaded content includes the sword. The purchaser uses menu button 580 to customize the voucher content.

When the purchaser uses the menu button 580 to customize the voucher content, a wish-list of the purchaser and a wish-list of the recipient are displayed to the purchaser. A wish-list includes items similar with electronic fund 520 or articles 540. The purchaser's wish-list may include both electronic funds and articles pre-selected by the purchaser. The recipient's wish-list may include both electronic funds and articles pre-selected by the recipient. The wish-list includes not only articles that have been produced but also articles that yet need to be produced. For example, when a recipient plays a demo of a video game that is still under developing, the recipient may add the to-be-produced video game in the wish-list. When a recipient creates wish-list, the recipient determines who is allowed to read the wish-list.

To customize the voucher, the purchaser may add one or more messages to the voucher. The message may be in a text form, in an audio form, or in a graphic form such as pictures or videos. When the recipient redeems the voucher, the message is displayed to the recipient.

FIG. 6 shows an example of a display 600 that may be used to generate a voucher including video games according to an embodiment of the present invention. Display 600 may be accessed by the purchaser selecting video content (selection button 542 in FIG. 5). The video content 542 includes, for example, various video games that may be selected as content for the voucher. As shown in FIG. 6, these include FINAL FANTASY VIII™ (602); VAGRANT STORY™ (604); and THE LEGEND OF DRAGOON™ (606). While three examples are shown, virtually any number of selection options may be displayed. As stated previously the voucher may include both electronic funds and/or tangible items and/or virtual items. Furthermore, menu selection 610 may be used to select customized content based on the other voucher content.

FIG. 7 shows a series of steps that may be used to redeem a voucher according to an embodiment of the present invention. As shown n FIG. 7, the series of steps may be represented as a flowchart 700 that may be executed by a processor, or otherwise executed to perform the identified functions and may also be stored in one or more memories and/or one or more electronic and/or computer-readable media. For example, the steps of FIG. 7 may be stored on a computer-readable medium, such as ROM, RAM, EEPROM, CD, DVD, or other non-volatile memory. The program code stored on an electronic memory medium is a structural element. The process 700 begins with start step 702.

A recipient accesses the voucher, typically after receiving the voucher (tangible) or notification of the voucher (electronic version), as shown in step 704. The recipient inputs the voucher code, which is validated, as shown in step 706. If the voucher code is not valid, as shown by “no” line 708, end step 790 is reached. If the voucher code is valid, “yes” line 710 shows that choices of possible articles are displayed to the receiver, as shown in step 712. Typically this choice menu is displayed at a terminal (i.e., element 202 of FIG. 1) or a kiosk (i.e., element 206 of FIG. 1).

The recipient selects desired items, as shown in step 714.

For example, the receiver, or recipient, may have an option to select digital currency, as shown in step 716. If so, “yes” line 717 leads to transferring the electronic funds to an account associated with the receiver, as shown in step 718. Step 720 determines if the recipient has an additional selection. If so, “yes” line 782 leads back to step 712 that displays the choices to the receiver. The recipient may select items during the additional selection. Thus, a recipient can select both electronic funds and items, provided both are associated with the voucher code

If no additional selections are available. “no” line 724 leads to end step 790.

If digital currency is not selected, in step 716, the user may select items associated with the voucher code, as shown in step 734. (Reached via “no” line 726.) The available items may include items such as: video games (735); game accessories, real or virtual (736); audio content (CDs, albums, soundtracks) (733); retail items (shirts, hats, clothing) (738); and priority items, that may be of special interest to the recipient based on the receiver's profile (740).

Once the items are selected, they are provided to the recipient, it is determined whether the recipient may return the selected item in step 752, or may exchange the selected item with another item in step 754, or may accept the selected item in step 756.

If it is determined in step 752 that the recipient may return the selected item, digital funds corresponding to the value of the selected item are returned to the online “wallet” or online account of the recipient. Then the process goes to step 746.

If it is determined in step 754 that the recipient may exchange the selected item with another item, available items of equivalent values are displayed to the recipient for selection. The available items may include products, games, games accessories, or downloadable digital contents offered by a store, a website, or a retailer. The available items may also include items offered by any user of the system. (The equivalent feature is described in more detail in relation to FIG. 12.) When a user of the system offers an item for exchange, the user sets a value of the offered item in term of a currency or digital funds. Then the process goes to step 746.

If it is determined that the recipient may accept the selected item in step 756, the selected item may be downloaded to the recipient's terminal or account or may be delivered to the recipient either by mail or by person. Then the process goes to step 746.

A determination is made as to whether any additional selection is available to the receiver, as shown in step 746. If so, “yes” line 748 shows that step 712 is reached, which displays remaining choices to the receiver. If there are no more available choices, then “no” line 750 leads to end step 790.

As shown in FIG. 7, a recipient can select both electronic funds and items, (real and/or virtual) provided the content is associated with the voucher code. The recipient can select as much money and/or as many items as the voucher is associated with.

FIG. 8 shows a menu display 800 with selected voucher content for a user to choose. For example, the voucher may be redeemed for $50.00 of electronic funds, as shown by 802. Alternatively, the voucher may be redeemed for $20.00 of electronic funds and video games, as shown by 804. The video games may be pre-selected as a particular video game or the recipient may have a list of possible video games to select from. Alternatively, the voucher may be redeemed for $10.00 in electronic funds and accessories, as shown by 806. The accessories may be pre-selected as a particular accessory or the recipient may have a list of possible accessories to select from.

Element 818 shows that the purchaser or provider may select that the money 802 selected may be exchanged by the recipient. Element 812 shows that the purchaser or provider may select that the money and video game 804 selected may be exchanged by the recipient. Element 810 shows that the money and accessory selected by the purchaser or provider may be exchanged by the recipient. Thus while three examples are shown in FIG. 8, any combination or permutation or money and or items selected by the purchaser or provider may be designated as capable of being exchanged by the recipient.

When the recipient accesses the digital fund or articles associated with the voucher, the message added by the purchaser is displayed to the recipient. At the same time, a recognition message is transmitted to the purchaser and displayed to the purchaser. The recognition message may be a standard pre-compiled message or may be a customized message input by the recipient. The recognition message is displayed to the purchaser regardless of whether the purchaser chooses to return, exchange, or accept an item accessible by the voucher. The recognition message is sent each time the recipient selected an item. The message added by the purchaser is displayed more than once when the recipient utilizes the voucher for accessing associated items. (This is described in more detail in relation to FIG. 11.)

FIG. 9 shows a billing algorithm 900 according to an embodiment of the present invention. As shown in FIG. 9, the algorithm may be represented as a series of steps that may be used to generate a bill or invoice for a voucher according to an embodiment of the present invention. FIG. 9 shows a flowchart of steps 900 that may be executed by a processor, or otherwise executed to perform the identified functions and may also be stored in one or more memories and/or one or more electronic and/or computer-readable media. For example, the steps of FIG. 9 may be stored on a computer-readable medium, such as ROM, RAM, EEPROM, CD, DVD, or other non-volatile memory. The program code stored on an electronic memory medium is a structural element.

The process 900 begins with start step 902. An identification of items desired for the voucher is shown in step 904. The items may be selected from a menu that includes first items (funds 906) and second items (articles (tangible and/or virtual) 910). The menu may be populated based on all available items, items related to a recipient profile (905), popular items (907) and items related to other selected items (909).

The cost of the voucher, including a total of items selected and funds selected is calculated, as shown in step 916. The purchaser is provided an opportunity to add more items and/or funds or decrease the amount of items and/or funds, thereby adjusting the cost of the voucher, as shown in step 918 and “yes” line 920, which leads back to the identification step. The billing algorithm 900 may be used to display to a purchaser the amount of money the voucher is going to cost prior to finalizing the voucher. Thus, as shown in step 918, the amount of money that the voucher will cost can be increased or decreased.

When the cost of the voucher is acceptable, the purchaser finalizes the selection of the funds and/or items, as shown in step 924. The content of the voucher is associated with the voucher (voucher code), as shown in step 926. An invoice for the cost of the voucher is generated as shown in step 928. The invoice may be printed (output); stored or emailed to an electronic address. Also, the purchaser may pay with a credit card, debit card or other electronic payment method. End step 930 is then reached.

FIG. 10 shows an example of an electronic representation of a voucher 1000 according to an embodiment of the present invention. The electronic voucher 1000 may be emailed to a desired terminal (for example, terminal 202 or kiosk 206 as shown in FIG. 1) and displayed to a user. The electronic voucher 1000 may have an electronic scratch-off portion 1016 that a user may “scratch-off” using an input such as a mouse, track ball, keyboard to provide the user with the experience of scratching-off the electronic obscuring layer 1016 to reveal the voucher code 1012. User name (1002), Account Number 1004, Expiration Date 1008 and barcode 1014 are also shown in FIG. 10.

As described herein, embodiments of the present invention enable a single voucher code to unlock/entitle the user (recipient) to digital products and funds, and provides a “gifting” feature into the voucher system. Furthermore, the purchaser has authority over what content goes on a voucher or a card. The system permits the purchaser customize the content that goes on the voucher or the card through a retail kiosk, a point of sale, or an online website. The system also adds elements such as a wish-list and a recognition message from the purchaser to the recipient and also permits the recipient to send a “thank you” or other acknowledgement of receipt to the purchaser.

Using this system, purchasers of a voucher or a card may use a retail kiosk, log into an account, add items and/or digital funds of their choice and simply click to generate a voucher code that may be printed onto the voucher or the card or may be transmitted electronically. This system allows both purchasers and recipients maintain a wish-list and allows a purchaser to view the wish-list of a recipient. Purchasers may also put a personal message, in either the form of text or video. With this system, an “impersonal” stigma may be eliminated, and a voucher or a card may be a personalized and well-thought-out gift for recipients.

Embodiments of this invention provide a choice to recipients. Recipients may receive a card with the voucher code. If recipients do not want to receive the particular product listed on the card, recipients may return/exchange the item for digital funds in an account or another item of equivalent value. When a recipient plays a digital content given by a purchaser, a recognition message may appear on a screen of the purchaser. Specifically, if a Playstation® network is used, the recognition message appears on an Xross Media Bar and profile. Also, the recipient may access a message that is displayed on the screen of the recipient. The message may be from the purchaser and may include content provided by the purchaser, such as a text message, and/or video data, and/or audio data. This content may be personalized by the purchaser or selected from standard content. The message from the purchaser may be displayed on the recipient's screen when the recipient utilizes the item accessed by the voucher code.

An embodiment of a voucher generation algorithm is explained in detail in relation to FIG. 11.

After a start 1102 of the voucher generation algorithm 1100, a purchaser selects an option from “sign in with an account number” (step 1103) “set up a new account” (step 1105) and “guest” (step 1104). Step 1103, “sign in with an account member”, allows the purchaser to log in to his/her account and generate a voucher. Step 1105, “set up a new account”, allows the purchaser to set up a new account and log in with the new account number. Step 1104, “guest”, allows the purchaser to generate a voucher without an account. In the next step 1106, the purchaser identifies a recipient of the voucher. To identify a recipient, the purchaser may choose a recipient from a friend list (step 1108) or choose the recipient by a search process (step 1110). The friend list may be prepared by the purchaser in advance. The friend list may also be generated by the system according to a profile of the purchaser, such as players being at the same party as the purchaser and members of a favorite group of the purchaser. The search process allows the purchaser to select a recipient by searching all the users according to age, favorite games, and profiles of a user.

After the recipient is identified, the algorithm, 1100, displays three voucher options to the purchaser: a product option (step 1112), a product plus fund option (step 1114) and a fund option (step 1116). The product option (1112) allows the purchaser to generate a voucher only associated with products. The product plus fund option (1114) allows the purchaser to generate a voucher associated with both products and digital funds. The fund option (1110) allows the purchaser to generate a voucher only associated with digital funds. The purchaser selects one from the three options.

If the purchaser selects to generate a voucher only associated with products, a plurality of products are displayed to the purchaser in step 1118. The purchaser may select product based on price ranges, functions of products, names of games, or experience levels if a character or a weapon used in a game to be selected. Step 1118 also allows the purchaser to determine an attribute of a selected product. Attributes of a product may indicate whether the product is exchangeable or returnable when a recipient accesses the product. (Other attributes include, for example, a message described in relation to steps 1140, 1142, 1146, 1148 and 1150 herein.) After the purchaser selects a product, the algorithm, 1100, generates a list of products that may be considered as equivalent products in step 1120 and allows the user to select one or more products from the list of equivalent products in step 1120. This provides the recipient with a selection of equivalent items that may be exchanged for an item associated with the voucher code. The algorithm, 1100, generates the list of equivalent products based on the price range of the product selected in step 1118. The list expands a gift idea of a purchaser by including additional equivalent products that may potentially attract the purchaser's interests. After the step 1120, the cost of the selected products is calculated and displayed to the purchaser as shown in step 1122. In step 1123, it is determined whether another product is preferred. If another product is preferred, the process goes to step 1118. If no more products is preferred, the process goes to step 1138.

If the purchaser selects to associate the voucher with both product plus fund (step 1124), step 1126 allows the purchaser to first determine the amount of fund to be associated with the voucher. Step 1128 is substantially the same as the step of 1118. A plurality of products are displayed to the purchaser in step 1128. After the purchaser selects a product (1128), a list of products that may be considered as equivalent products is generated in and allows the user to select one or more products from the list of equivalent products in step 1130. Step 1132 calculates the cost of both the selected funds and the selected product(s). Then, in step 1134, it is determined whether the purchaser wants to add another item and/or additional funds to the voucher. If another item(s)/funds is/are desired, step 1126 is reached. If another item(s)/fund(s) is/are not preferred, step 1138 is reached.

If the purchaser selects to associate funds with the voucher, the purchaser is allowed to select any amount of funds and then the process goes to step 1136, which calculates the cost. Then, the process goes to step 1138.

In step 1138, it is determined whether the purchaser wants to adjust the voucher. If the purchaser wants to make adjustments, the process goes to step 1106 (by “yes” line 1139). If the purchaser does not want to make adjustments, the process goes to step 1140 (by “no” line 1137) to generate a message along with the voucher.

In step 1140, the purchaser may use a predetermined template provided in step 1142 to compile the message (the message being another attribute). The purchaser may add text (step 1146), audio (1148), and video information (1150) to the message.

After the message is generated in step 1140, step 1152 allows the purchaser to generate the voucher. The purchaser may choose to generate the voucher by email (step 1154), print out on a tangible medium (step 1156), or storage (step 1158). Step 1154 generates a voucher and emails the voucher to the recipient. Step 1156 prints out the voucher on a card or a paper and allows the recipient to keep the voucher. Step 1158 stores the voucher in the recipient's account, which may be for example a memory location on a Playstation® device.

Step 1170 shows that a new record may be added to the recipient's online wallet or online account. The record may include information of cost of the voucher, the name of the recipient, associated items, dates, whether the voucher has been sent out or not, and whether the voucher has been redeemed or not. The record also includes any thank you note sent back by the recipient.

In another embodiment of the present invention, the price or the cost of the voucher is not disclosed to the recipient so the recipient has no knowledge of the amount the purchaser spent on the voucher.

The method 1100 ends at end step 1180.

An embodiment of a voucher redemption algorithm is explained in detail in relation to FIG. 12.

The voucher redemption algorithm 1200 begins with start step 1201. A recipient selects an option from “sign in with an account number” (step 1202) and “set up a new account” (step 1204). Step 1202 “sign in with an account member”, allows the recipient to log in to his/her account and then redeem a voucher. Step 1204, “set up a new account”, allows the recipient to set up a new account and log in with the new account number. A user having an account will be permitted to redeem a voucher. In the next process, 1208, the recipient inputs a voucher either by typing in a plurality of numbers and characters or by clicking a link in an email or by scanning a bar code on a paper or a card. In step 1210, it is determined whether the voucher is valid or not by a comparison between the input voucher and a system record. If the voucher is valid, “yes” line 1213 leads to step 1212. If the voucher is invalid, “no” line 1211 leads to step 1208. Step 1212 displays associated items to the recipient. The associated items may include both products (step 1214) and/or funds (step 1218). The recipient selects either an associated product or fund to proceed or a combination of products and funds, if associated with the voucher code. Whenever a selection of a product or a fund is determined, a recognition message may be sent to the purchaser as shown in step 1220 and step 1222 for a product selection. The recognition message may include the selected product's name, amount of funds and may be sent only once for each product or fund or may be sent each time the recipient access the gifted item or spends a portion of the gifted funds. The recognition message may also include an identification of the voucher, an identification of the purchaser, and an identification of the product selected by the recipient and any items exchanged by the recipient.

If the recipient selects a product in step 1224, the algorithm 1200 displays three options to the recipient: “accept” (step 1226), “return” (step 1228), and “exchange” (step 1230). If a purchaser sets an attribute of an item, the algorithm 1200 displays only those options consistent with the attributes set by the purchaser. For example, if a purchaser does not allow an item to be returned, the return option may not be displayed. The option of “accept” will allow the recipient to simply receive the product. If the accepted product is a digital product, it will be downloaded to the recipient's account. If the accepted product is a non-digital product, the recipient may receive it from a local store. If the recipient chooses to return a selected product, step 1232 calculates the value of the product and credits the equivalent amount of fund back to the recipient's account or generates a fund voucher if the recipient does not have an account. If the recipient chooses to exchange the selected product, step 1234 generates a list of equivalent products and displays the list to the recipient for selection. The generation of a list of equivalent products is substantially the same as those of step 1120 in FIG. 11. Further, step 1234 allows a recipient to search for an equivalent product based on criteria given by the recipient.

If the recipient selects a fund, the amount of fund associated with the voucher is credited to the account or wallet of the recipient.

After a selection of either a product and/or a fund, the process goes to step 1238 to determine whether the recipient wants to make another selection. If the recipient wants to make another selection, the process goes to step 1212, via line 1239. If the recipient does not want to make another selection, the process goes to step 1240, via line 1237.

Step 1240 displays the message added by the purchaser to the recipient. Then, the process goes to step 1242 to allow the recipient to send back a thank you message to the purchaser. Step 1244 allows the recipient to send back a thank you message by email or step 1246 allows the recipient to send back a thank you message by mail. The “mail” thank you may be a letter printed out at the recipient's terminal that the recipient can then mail to the purchaser.

Step 1260 shows the algorithm 1200 ends.

It will be appreciated from the above that the invention may be implemented as computer software, which may be supplied on a storage medium or via a transmission medium such as a local-area network or a wide-area network, such as the Internet. It is to be further understood that, because some of the constituent system components and method steps depicted in the accompanying Figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

It is to be understood that the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

What is claimed is:

1. A voucher system for utilizing vouchers via a network, comprising:
a generation module adapted to generate a voucher code upon a request of a purchaser,
wherein the voucher code is associated with one or more items selected by the purchaser, such that the purchaser can assign one or more attributes to each of the one or more items,
a redemption module adapted to utilize the voucher code such that a recipient, upon validation of the voucher code, accesses the associated one or more items, and
wherein upon redeeming the voucher, the recipient receives the associated one or more items at a designated user account, and receives notification of the one or more attributes assigned to each of the one or more items.

2. The voucher system according to claim 1, wherein the attribute indicates that an associated item is returnable.

3. The voucher system according to claim 1, wherein the attribute indicates that an associated item is exchangeable for another equivalent item or an equivalent amount of electronic funds.

4. The voucher system according to claim 1, wherein the redemption module displays options associated with each of the one or more items to the recipient in accordance with the attribute assigned by the purchaser.

5. The voucher system according to claim 1, wherein the generation module prints the voucher code on a card.

6. The voucher system according to claim 1, wherein the generation module generates a list of items that have equivalent values with an item selected by the purchaser.

7. The voucher system according to claim 1, wherein the attribute associates a message in a text form or a graphical form with the voucher code.

8. The voucher system according to claim 1, wherein when the recipient accesses an associated item upon redeeming the voucher code, a recognition message is transmitted to the purchaser.

9. The voucher system according to claim 1, wherein the associated items include one or more of predetermined digital funds and one or more of downloadable digital contents.

10. The voucher system according to claim 1, wherein the redemption module is a Playstation3 terminal, a Playstation®Portable, or Media Go.

11. The voucher system according to claim 1, wherein the recipient exchanges the associated items with other items of equivalent value upon utilizing the voucher code.

12. The voucher system according to claim 11, wherein the redemption module generates a list of items that have equivalent values with the associated item.

13. The voucher system according to claim 1, wherein the purchaser modifies a cost of the voucher by modifying selection of the one or more items associated with the voucher.

14. The voucher system according to claim 1, wherein the generation module permits the purchaser to select an item to be associated with the voucher code from a pre-determined list associated with the recipient.

15. A method for utilizing vouchers comprising:
generating a voucher code upon a request of a purchaser;
associating the voucher code with one or more items, the items being selected by the purchaser, such that the purchaser can assign one or more attributes to each of the one or more items,
redeeming the voucher code so that a recipient, upon validation of the voucher code, accesses the associated one or more items, and
wherein upon redeeming the voucher, the recipient receives the associated one or more items at a designated user account, and receives notification of the one or more attributes assigned to each of the one or more items.

16. The method according to claim 15, wherein the attribute indicates that an associated item is returnable.

17. The method according to claim 15, wherein the attribute indicates that an associated item is exchangeable is for another equivalent item or an equivalent amount of electronic funds.

18. The method according to claim 15, further comprising displaying options associated with each of the one or more items to the recipient in accordance with the attribute assigned by the purchaser.

19. The method according to claim 15, further comprising printing the voucher code on a card.

20. The method according to claim 15, further comprising generating a list of items that have equivalent values with an item selected by the purchaser.

21. The method according to claim 15, wherein the attribute associates a message in a text form or a graphical form with the voucher code.

22. The method according to claim 15, further comprising transmitting a recognition message to the purchaser when the recipient accesses an item provided by the purchaser.

23. The method according to claim 15, wherein the associated items include one or more of predetermined digital funds and one or more of downloadable digital contents.

24. The method according to claim 15, further comprising exchanging the associated items with other items of equivalent value upon utilizing the voucher code.

25. The method according to claim 24, further comprising generating a list of items that have equivalent values with the associated item.

26. The method according to claim 15, further comprising modifying a cost of the voucher by modifying selection of the one or more items associated with the voucher by the purchaser.

27. The method according to claim 15, further comprising identifying an item to be associated with the voucher code from a pre-determined list associated with the recipient.
